(19) United States
(12) Patent Application Publication
(10) Pub. No.: US 2006/0072526 A1
(43) Pub. Date: Apr. 6, 2006

(54) Change of resource reservation for an IP session

(75) Inventor: Juha A. Rasanen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/029,339

(22) Filed: Jan. 6, 2005

(30) Foreign Application Priority Data
Oct. 4, 2004 (EP) 04 023 613.5

(51) Int. Cl. H04Q 7/24; H04L 12/56

(52) U.S. Cl. 370/338; 370/468; 370/352

(57) ABSTRACT

A method modifies a Packet Data Protocol context during an IP session. The method includes activating a Packet Data Protocol context with a first Quality of Service setting by a user equipment. The method also includes detecting whether there is a changed demand for resources within the session. The method also includes modifying the packet data protocol context so that the first quality of service setting is changed into a second quality of service setting different from the first one. Each time a changed demand for resources within the session is detected, the second Quality of Service setting corresponds to the changed demand for resources.

### FIELD OF THE INVENTION

The present invention relates to a method, system and network device which modify a Packet Data Protocol context during an IP session such as a Push to Talk over Cellular session.

### BACKGROUND OF THE INVENTION

The Push to Talk over Cellular (PoC) service is introduced as an application within the frame of the IP (Internet Protocol) Multimedia Subsystem (IMS). FIG. 1 illustrates how the PoC service elements fit into the IMS architecture (The Interrogating Call State Control Function (I-CSCF) is not shown for the sake of simplicity).

According to recent developments, IMS is leveraged as the underlying SIP-based (Session Initiation Protocol) IP-core network.

The PoC server implementing the application level network functionality for the PoC service is essentially seen as an Application Server from the IMS perspective. IMS core and the PoC server utilize the ISC (IP Multimedia Session Control) interface.

Further, the Group and List Management Server (GLMS) is used by the PoC users to manage groups and lists (e.g. contact and access lists) that are needed for the PoC service. In the IMS architecture, the Ut interface provides these functions, hence communications between the GLMS and the UE utilize the Ut interface.

A Presence Server may provide availability information about PoC users to other PoC users.

There are two mechanisms for session establishment signaling supported. In both scenarios, the session is first established between the PoC user (originating or terminating) and the PoC server serving the user and then the other party is invited to the session.

The mechanisms for session set-up are described in the following in more detail.

The On-Demand Session provides a mechanism to negotiate media parameters such as IP address, ports and codecs, which are used for sending the media and floor control packets between the PoC Client and the home PoC Server when the user wants to actually establish a PoC session. This mechanism allows the PoC Client to invite, via PoC server(s), other PoC clients or receive PoC sessions by using the full session establishment procedure each time the user wants to establish/receive/join a PoC session. Media parameters may be negotiated again in this mechanism.

The pre-established session provides a mechanism to negotiate media parameters such as IP address, ports and codecs, which are used for sending the media and floor control packets between the PoC Client and the home PoC Server before establishing the PoC session. This mechanism allows the PoC Client to invite other PoC clients or receive PoC sessions without negotiating again the media parameters. After the pre-established session has been set up (once the PoC user has registered), the PoC Client is able to activate media bearer whenever needed, that is, immediately after the general PoC session pre-establishment procedure or when the actual SIP signaling for the PoC media session establishment is initiated.

The On-demand Session is described in the following in still more detail by making reference to FIG. 2.

A simplified high-level PoC session flow is shown below when using GPRS bearer. The flow shows a general case and relation of PDP (Packet Data Protocol) context with PoC/IMS session and does not show any special order or requirement of whether separate PDP context is required for the media or not.

The simplified steps for establishing PoC communication based upon on-demand signaling are:

1. Each terminal is powered on which may occur at different times for each terminal.

2. Each terminal performs PS (Packet Switched) attach in order to authenticate to the PS domain which also may occur at different times for each terminal.

3. Each terminal establishes the PDP context to establish any kind of communication. Again, this may occur at different times for each terminal. The use of this PDP context bearer can be realized in different ways depending on how the terminal, network and overall system is configured to operate.

4. Each terminal performs the IMS registration which may occur at different times for each terminal.

5. User A presses the push-to-talk indication/button on the terminal A to indicate that he wishes to communicate to the user at terminal B. Step 5 can occur anytime after step 4 has been performed, there is no timing correlation between these steps once steps 1-4 have been performed.

6. In case terminal A does not have a PDP Context active for the media or floor control exchange, it establishes a PDP Context (6a), and creates a SIP session for the PoC communication by sending the SIP INVITE into the IMS (6b). The INVITE request contains the PoC service indication; the S-CSCF (Serving Call State Control Function) identifies that this service indication matches ISC filtering information and routes the session establishment request to the PoC Application Server (AS). At present, it is not defined whether the Quality of Service (QoS) of the pre-established PDP context is allowed to have a higher QoS than “best effort”. In case Service Based Local Policy is applied in terminal A's network, PDF(A) (Policy Decision Function) generates an authorization token for the session, and P-CSCF(A) (Proxy Call State Control Function) inserts and delivers it to the terminal in the first available reliable SIP response (in this case the 200OK). In this case, the terminal inserts the authorization token in a PDP Context modification for the media depicted in step 8b. The establishment of PDP context for media is optional, depending on the configuration of the IM/PoC application. 7. As this is an “early media flow”, the PoC AS (after determining that the PoC communication should be completed), together with the IMS, forwards the invite to the terminating terminal for the PoC communication. In case Service Based Local Policy is applied in Terminal B's network, PDF (B) generates an authorization token for the session, and P-CSCF(B) inserts and delivers it to the terminal in the INVITE request. The PoC AS, together with the IMS, completes the originating session by returning the 200 OK to terminal A.
8-9. After receiving the INVITE (7), terminal B accepts the session by returning 200OK and establishes the PDP context for the media. Depending on the terminal setting (automatic answer mode or manual answer mode), the PDP context may be established in different order. In case Service Based Local Policy is applied in Terminal B's network, the terminal inserts the authorization token received in the INVITE request into the PDP Context activation request.

10. The PoC AS performs the floor control, informing terminal A that he has the floor, and informing terminal B of whom has the floor.

11. The media is transferred from terminal A to terminal B. The Pre-established Session is described in the following in still more detail by making reference to FIG. 3.

A simplified high-level PoC session flow is shown below when using GPRS (General Packet Radio Service) bearer. The flow shows a general case and relation of PDP context with IMS session and does not show any special order or requirement of whether separate PDP context is required for the media or not. This flow assumes (though it is not required for both sides to use the same mechanism) that both originating and terminating PoC user uses the Pre-established session mechanism.

The simplified steps for establishing PoC communication based upon on Pre-established Session signaling are:

1. Each terminal is powered on which may occur at different times for each terminal.

2. Each terminal performs PS attach in order to authenticate to the PS domain which may also occur at different times for each terminal.

3. Each terminal establishes a PDP context. Again, this may occur at different times for each terminal. The use of this PDP context bearer can be realized in different ways depending on how the terminal, network and overall system is configured to operate.

4. Each terminal performs the IMS registration which may occur at different times for each terminal.

5. Each terminal establishes the Pre-established Session for PoC communication towards the PoC AS. The INVITE request contains the PoC service indication; the S-CSCF identifies that this service indication matches ISC filtering information and routes the session establishment request to the PoC AS. In case Service Based Local Policy is applied in the terminal's IMS network, the authorization token will be generated by the PDF, inserted and delivered by the P-CSCF to the terminal upon set-up of the pre-established session (in the 200OK response). This Pre-established Session set-up may occur at different times for each terminal. Once the session relationship is established, it remains as long as the user wishes to remain connected to the PoC server.

6. After establishing the pre session for PoC communication, each terminal may establish the PDP context for media depending on the scenario supported where media transfer requires separate PDP context. In case Service Based Local Policy is applied, the terminal includes the authorization token it has received at step 5 into the PDP Context activation/modification request. The time that step 6 takes place (immediately after step 5 or after step 7) may need to be determined based on the required QoS traffic class. The possibility to use an interactive traffic class for the initially established PDP context immediately after step 5 and then modify the PDP context for a higher QoS traffic class after step 7 is proposed.

7. User A presses the push-to-talk indication/button on the terminal A to indicate that he wishes to communicate to the user at terminal B.

8. Terminal A sends, for example, in a SIP REFER message to the PoC AS via the IMS, containing the address of the terminating user.

9. The PoC AS uses the floor control in order to inform the terminating terminal that a terminating PoC communication is incoming.

10. The PoC AS acknowledges the REFER messages.

11. The PoC AS completes the floor control to the originating terminal to inform the terminal that it has the floor.

12. The media is transferred from terminal A to terminal B.

According to the above described prior art, when a PoC user joins a group or activates a one-to-one session, resources are reserved for the session, e.g. a PDP context is activated. If the streaming class or the conversational class is used, a resource reservation means also that a certain guaranteed bit rate or bandwidth is reserved in the packet core and radio network for the session. The resources are continuously reserved even if the user does not have any traffic. Especially a group session may be on-going for a long period, e.g. a working day, even on a permanent basis, depending on the user application. However, a continuous reservation of network resources (guaranteed bit rate/bandwidth) will inevitably cost a corresponding amount of money for the user, even if she/he did not actually use the resources.

Similar problems occur in IP sessions other than a Push to Talk over Cellular session, when resources are reserved for the session.

### SUMMARY OF THE INVENTION

Therefore, it is an object of the present invention to overcome the above described shortcomings of the prior art.

According to one aspect of the present invention, this object is solved by a method which modifies a Packet Data Protocol context during an IP session, comprising: activating a Packet Data Protocol context with a first Quality of Service setting by a user equipment; detecting whether there is a changed demand for resources within the session; and modifying the Packet Data Protocol context so that the first Quality of Service setting is changed into a second Quality of Service setting different from the first one, each time a changed demand for resources within the session is detected, wherein the second Quality of Service setting corresponds to the changed demand for resources.

According to another aspect of the present invention, the object is solved by a method which modifies a Packet Data Protocol context during an IP session, comprising: activating a Packet Data Protocol context with a first Quality of Service setting by a user equipment; detecting whether there is a changed demand for resources within the session and, if it is detected that the changed demand for resources corresponds to a higher demand, modifying the Packet Data Protocol context so that the first Quality of Service setting is changed into a second Quality of Service setting different from the first one, wherein the second Quality of Service setting corresponds to the changed demand for resources, and if it is detected that the changed demand for resources corresponds to a lower demand, starting a timer and executing the modifying step only if the timer expires without detecting another changed demand for resources corresponding to a higher demand with respect to the lower demand.

According to a first modification of the above two aspects, the IP session is a Push to Talk over Cellular session.

According to a second modification of the above two aspects, the detecting step includes that the changed demand is triggered by a signaling event. The signaling event may be one of the group of detecting speech input at the user equipment, the receipt of Real-Time Protocol packets by using packet filters, or detecting floor control signaling.

According to a third modification, the first modification is further modified so that the first Quality of Service setting corresponds to one of the group of a best effort class and an interactive class, and the second Quality of Service setting corresponds to one of the group of an uplink streaming class, downlink streaming class and conversational class.

According to a fourth modification, the first modification is further modified so that the first Quality of Service setting corresponds to one of the group of an uplink streaming class, downlink streaming class and conversational class, and the second Quality of Service setting corresponds to one of the group of a best effort class and an interactive class.

According to still another aspect of the present invention, the object is solved by a system which is configured to modify a Packet Data Protocol context during an IP session, comprising: at least one user equipment configured to activate a Packet Data Protocol context with a first Quality of Service setting; and at least one network element configured to detect a changed demand for resources within the session and provided with an ability to modify the Packet Data Protocol context as an automated response to a changed demand for resources within the session so that the first Quality of Service setting is changed into a second Quality of Service setting different from the first Quality of Service setting, wherein the second Quality of Service setting corresponds to the changed demand for resources.

According to a first modification of this aspect, the system is configured so that the IP session is a Push to Talk over Cellular session.

According to a second modification of this aspect, the configuration of the network element includes that the detected changed demand is a signaling event. The signaling event may be one of the group of detected speech input at the network element, detected speech input at the user equipment, the receipt of Real-Time Protocol packets by using packet filters, or detected floor control signaling.

According to a third modification of this aspect, the network element comprises a timer and is further configured, if it is detected that the changed demand for resources corresponds to a lower demand, to start the timer, and to modify the Packet Data Protocol context only if the timer expires without detecting another changed demand for resources corresponding to a higher demand with respect to the lower demand.

According to a fourth modification of this aspect, the first modification is further modified so that the first Quality of Service setting corresponds to one of the group of a best effort class and an interactive class, and the second Quality of Service setting corresponds to one of the group of an uplink streaming class, downlink streaming class and conversational class.

According to a fifth modification of this aspect, the first modification is further modified so that the first Quality of Service setting corresponds to one of the group of an uplink streaming class, downlink streaming class and conversational class, and the second Quality of Service setting corresponds to one of the group of a best effort class and an interactive class.

According to still another aspect of the present invention, the object is solved by a network device which is configured to modify a Packet Data Protocol context during an IP session, wherein the configuration includes that it is detected whether there is a changed demand for resources within the session, and that an ability is provided to modify the Packet Data Protocol context as an automated response to a changed demand for resources within the session, wherein a first Quality of Service setting is changed into a second Quality of Service setting different from the first Quality of Service setting, and the second Quality of Service setting corresponds to the changed demand for resources.

According to a first modification of this aspect, the configuration to detect includes that the changed demand is a signaling event. In this case, the configuration to detect may comprise packet filter arranged to receive Real-Time Protocol packets as the signaling event. Alternatively, the configuration to detect may comprise detected speech input as the signaling event. Still alternatively, the configuration to detect may comprise detected floor control signaling as the signaling event.

According to a second modification of this aspect, further comprised is a timer, wherein the configuration further includes, if it is detected that the changed demand for resources corresponds to a lower demand, that the timer is started, and that the Packet Data Protocol context is modified only if the timer expires without detecting another changed demand for resources corresponding to a higher demand with respect to the lower demand.

According to a third modification of this aspect, the configuration includes that the IP session is a Push to Talk over Cellular session.

According to a fourth modification of this aspect, the third modification is further modified so that the first Quality of Service setting corresponds to one of the group of a best effort class and an interactive class, and the second Quality of Service setting corresponds to one of the group of an uplink streaming class, downlink streaming class and conversational class.

According to a fifth modification of this aspect, the third modification is further modified so that the first Quality of Service setting corresponds to one of the group of an uplink streaming class, downlink streaming class and conversational class, and the second Quality of Service setting corresponds to one of the group of a best effort class and an interactive class.

According to certain modifications of aspects of the present invention described above, various advantages are achieved such as there is no need for a permanent and costly resource (bit rate/bandwidth) reservation when the UE joins a PoC group or sets up a one-to-one PoC session.

### BRIEF DESCRIPTION OF THE DRAWINGS

Further objects, details, advantages and modifications of the present invention will become apparent from the following detailed description of the preferred embodiments which is to be taken in conjunction with the accompanying drawings, in which:

FIG. 1 shows the PoC service elements in the IMS architecture as a general environment of the present invention;

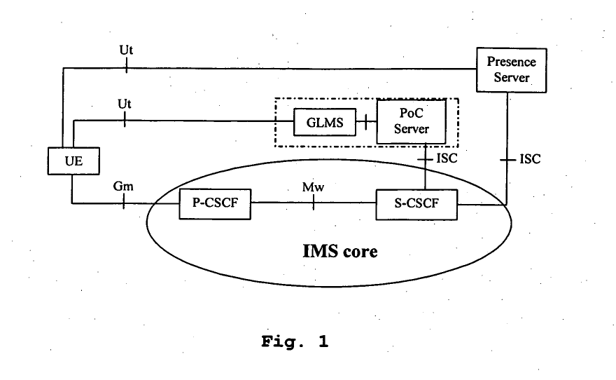

FIG. 2 shows a simplified PoC communication based on an “on demand” signaling;

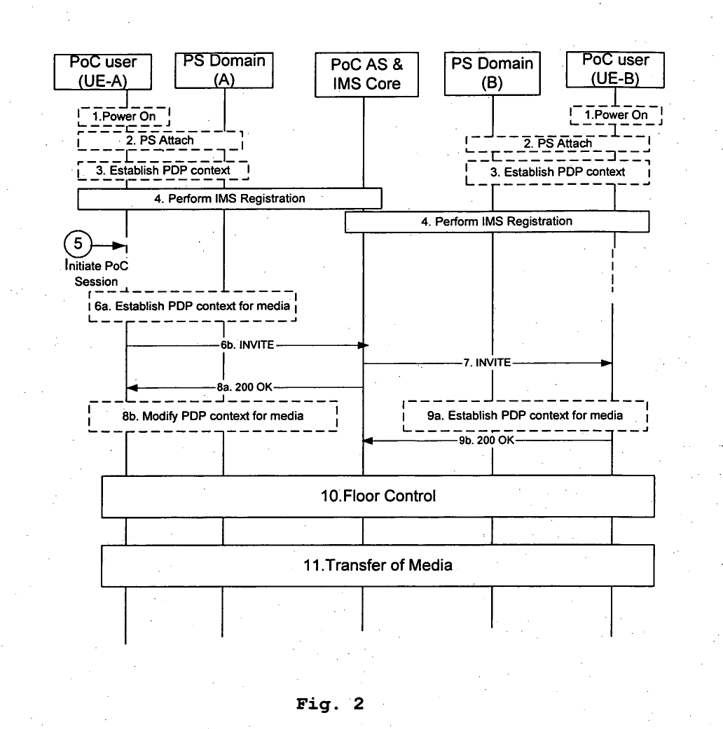

FIG. 3 shows a simplified PoC communication based on a “pre-established session” signaling; and

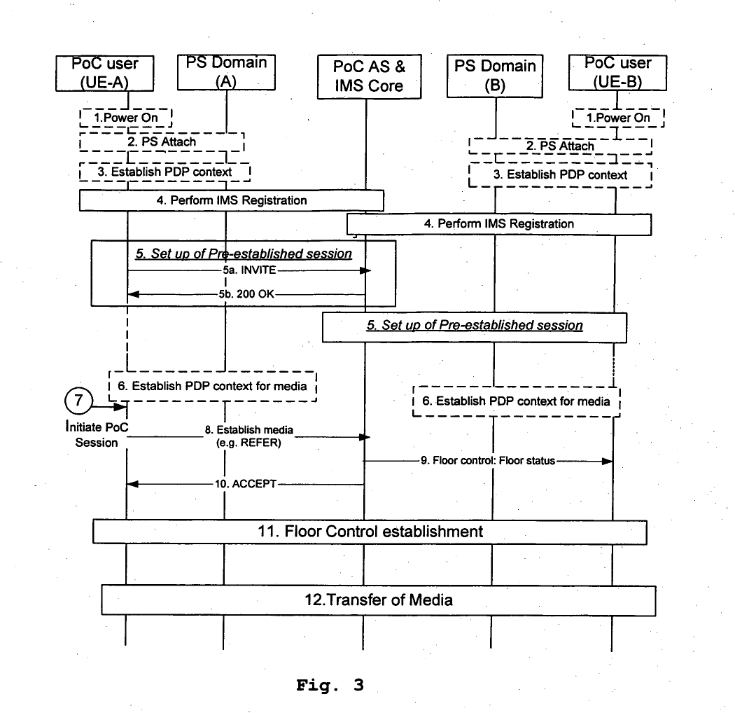

FIG. 4 shows key network elements according to preferred embodiments of the present invention.

### DETAILED DESCRIPTION OF THE PREFERRED EMBODIMENTS

One preferred embodiment of the present invention is that the IP session is a Push to Talk over Cellular session to which the present invention can be applied with many advantages as is readily apparent from the fact that the drawbacks discussed in the introductory section can be fully overcome. However, this is not to be construed as limiting the present invention in any way. Rather, many other applications can benefit from the present invention among which the Push to Talk over Cellular service is only an example chosen to illustrate the present invention and its advantages, and to present an implementation example.

Therefore, in the following, the embodiments of the present invention are described by referring to the Push to Talk over Cellular service as an implementation example only.

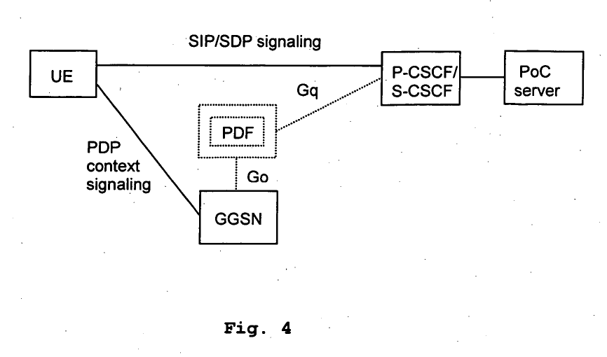

FIG. 4 shows key network elements according to preferred embodiments of the present invention. That is, there is a policy decision function within the network which is connected via the Go interface to a

Gateway GPRS Support Node (GGSN) which exchanges a PDP context signaling with a user equipment (UE). Another connection of the policy decision function is via the Gq interface to the Proxy Call State Control Function (P-CSCF)/Serving Call State Control Function (S-CSCF) to which the PoC Server is connected and with which the UE exchanges the Session Initiation Protocol (SIP)/Session Description Protocol (SDP) signaling.

According to embodiments of the present invention, the bandwidth reservation is optimized with the combined use of non-real-time (best effort, interactive) and real-time (streaming, conversational) traffic classes.

For example, when a PoC session is started, the PDP context is activated with the interactive class. When a user starts to talk, according to one embodiment, the user equipement (UE) modifies the PDP context with the conversational class or streaming class (guaranteed bandwidth). A timer is started to control the duration of the traffic after the speech activity has ended. When enough time has passed after the last traffic is sent, the PDP context is brought back to interactive class. Further, when the user starts to receive speech (speech input), the Real-Time Protocol (RTP) packets carrying the speech are recognised and the PDP context modification is activated to change the traffic class to conversational class or streaming class. Alternatively, floor control signalling to grant the floor for the UE can be used as an indication of incoming traffic, and the PDP context modification is activated to change the traffic class to conversational class or streaming class. A timer is again started to control the duration of the traffic after the speech activity is over. So when the timer expires the traffic class is changed to interactive class.

According to one embodiment of the present invention, it is also possible to change the traffic class only for one link direction. If e.g. a user is only listening to the PoC session, the traffic class needs to be changed only for the downlink direction.

Embodiments of the present invention include implementations into the UE or into the network or in both.

At the network side packet filters could be used for detecting the speech packets (RTP packets). When detecting traffic activity, according to one embodiment of the present invention, the Gateway GPRS Support Node (GGSN) initiates the PDP context modification. The GGSN would also use the timer functionality.

At the terminal side packet filters could also be used for detecting speech packets (RTP packets) in a relevant PDP context. According to one embodiment of the present invention, when detecting traffic activity, the UE initiates a PDP context modification to change the traffic class. The UE also uses the timer functionality.

In the following, preferred embodiments of the present invention are described by referring to certain situations during a session.

According to one embodiment of the present invention, when joining a group or setting up a one-to-one session, the user requests a real-time class (which is conversational class when bi-directional traffic is expected, and streaming class (but may also be conversational class) when unidirectional traffic is expected). The PDF authorizes the session accordingly, if Service Based Local Policy (SBLP) is applied to the used access point in the network.

The UE activates a PDP context with the best effort traffic/interactive class, i.e. no guaranteed bit rate/bandwidth is reserved for the session. The GGSN requests the authorization of the QoS from the PDF, if Service Based Local Policy (SBLP) is applied to the used access point in the network. The PDF acknowledges the request, if it is within the limits of the QoS authorized for the session. (Otherwise authorization is not granted until the GGSN and the UE renegotiate the requested QoS for the PDP context downwards.)

If there is UE originated speech activity, i.e. when the user starts to talk, the UE modifies the PDP context accordingly. If no reply is expected, the streaming class is set up in the uplink direction (although conversational class could also be used). If a reply is expected, the conversational class is set up. A timer is started to control the duration of the real-time traffic class after the speech activity is over. When the timer expires, the traffic class of the PDP context is brought back to best effort traffic/interactive.

If the UE receives speech, i.e. the user starts receiving speech, the RTP packets carrying the speech are recognized and a PDP context modification is activated to change the traffic class of the PDP context to real-time. Alternatively, floor control signalling to grant the floor for the UE can be used as an indication of incoming traffic, and the PDP context modification is activated to change the traffic class of the PDP context to real-time. If no reply is expected, the streaming class is set up in the downlink direction (although conversational class could also be used). If a reply is expected, the conversational class is set up. A timer is started to control the duration of the real-time traffic class after the speech activity is over.

According to some embodiments of the present invention, modifications may be made according to use cases. That is, the user may belong to a group where she/he is only speaking (1) or only listening (2) or both (3).

In case (1) the traffic class needs to be changed only for the uplink direction at PDP context modification, i.e. uplink streaming is sufficient.

In case (2) the traffic class needs to be changed only for the downlink direction at PDP context modification, i.e. downlink streaming is sufficient.

In case (3) the traffic class can be changed simultaneously for both directions, i.e. to conversational (as authorized at establishing the session) in order to have the better class already activated for the reply of the addressed party. Alternatively, according to a modified embodiment, each direction could also trigger the change of the PDP context independently of each other.

Hereinafter, preferred embodiments of the present invention are described according to implementation examples.

The operation can be implemented in the UE or in the network or in both.

In case of a Public Land Mobile Network (PLMN) according to the 3^{rd} Generation Partnership Project (3GPP), one implementation would be within the Gateway GPRS Support Node. Thus, corresponding to an implementation only in the network according to some preferred embodiments of the present invention, the packet filters (packet classifiers) are used for detecting speech packets (RTP packets) in a relevant PDP context. Alternatively, a floor control signaling between the UE and the PoC server can be monitored in the relevant PDP context to find out that floor has been granted to the UE, i.e. that user traffic is expected to start. When detecting such traffic activity, the GGSN initiates a PDP context modification to change the traffic class of the PDP context from best effort/interactive to streaming or conversational. The GGSN starts a timer to control the duration of the real-time traffic class after the speech activity is over.

If Service Based Local Policy (SBLP) is applied to the used access point in the network, the following applies. If the authorization given by the PDF is for a conversational/bi-directional session, the GGSN can modify both directions of the PDP context at the same time or only the activated direction, and wait for a possible activity in the opposite direction before changing its guaranteed bit rate/bandwidth. If the authorization is for a streaming/unidirectional session, the GGSN modifies only the activated direction.

When the implementation is only in the UE according to other preferred embodiments of the present invention, packet filters (with parameters like: IP addresses, port numbers, protocol, payload type or other RTP parameters) can be used for detecting speech packets (RTP packets) in a relevant PDP context. Alternatively, a floor control signaling between the UE and the PoC server can be monitored in the relevant PDP context to find out that floor has been granted to the UE, i.e. user traffic is expected to start. When detecting such traffic activity, the UE initiates a PDP context modification to change the traffic class of the PDP context from best effort/interactive to streaming or conversational. The UE starts a timer to control the duration of the real-time traffic class after the speech activity is over.

In the uplink direction there is no need for the UE to detect speech/RTP packets, if the user has to press a speech button when starting to speak, i.e. to “get the floor” as a result of floor control signaling. This can initiate the modification request. In the downlink direction the UE should detect the speech activity with a filter of the relevant session/application (using filter parameters like: IP addresses, port numbers, protocol, payload type or other RTP parameters). Alternatively, floor control signaling can trigger the PDP context modification.

If the UE originally (i.e. on the control plane signaling at the session establishment or at a later session modification) set up a conversational/bi-directional session, the UE can modify both directions of the PDP context at the same time, or only the activated direction and wait for a possible activity in the opposite direction before changing its guaranteed bit rate/bandwidth. If the UE originally (i.e. on the control plane signaling at the session establishment or at a later session modification) set up a streaming/unidirectional session, the UE modifies only the activated direction.

Further preferred embodiments of the present invention include implementation examples in the UE and the network. Various combinations are possible such as an uplink modification initiated by the UE and a downlink modification by the network, or that the UE originated speech activity initiates a modification for the active UE's PDP context and a network originated speech activity initiates a modification for the addressed UE's PDP context).

Accordingly, what is described above is a method which modifies a Packet Data Protocol context during an IP session, comprising: activating a Packet Data Protocol context with a first Quality of Service setting by a user equipment; detecting whether there is a changed demand for resources within the session; and modifying the Packet Data Protocol context so that the first Quality of Service setting is changed into a second Quality of Service setting different from the first one, each time a changed demand for resources within the session is detected, wherein the second Quality of Service setting corresponds to the changed demand for resources.

While it has been described above what is presently considered to be the preferred embodiments of the present invention, it is apparent to those skilled in the art that various modifications may be made without departing from the spirit and scope of present invention. It is therefore intended that all such modifications are covered by the appended claims.

1. A method which modifies a packet data protocol context during an IP session, the method comprising:
activating a packet data protocol context with a first quality of service setting by a user equipment;
detecting whether there is a changed demand for resources within a session; and
modifying the packet data protocol context so that the first quality of service setting is changed into a second quality of service setting different from the first quality of service setting, when the changed demand for resources within the session is detected,
wherein the second quality of service setting corresponds to the changed demand for resources.

2. A method which modifies a packet data protocol context during an IP session, the method comprising:
activating a packet data protocol context with a first quality of service setting by a user equipment;
detecting whether there is a changed demand for resources within a session, and
modifying the packet data protocol context so that the first quality of service setting is changed into a second quality of service setting different from the first quality of service setting if the changed demand for resources corresponds to a higher demand, wherein the second quality of service setting corresponds to the changed demand for resources, and
starting a timer and executing the modifying step if the timer expires without detecting another changed demand for resources corresponding to higher demand with respect to a lower demand if the changed demand for resources corresponds to a lower demand.

3. The method according to claim 1 or 2, wherein the session comprises a push to talk over cellular session.

4. The method according to claim 1 or 2, wherein the detecting step includes triggering the changed demand by a signaling event.

5. The method according to claim 4, wherein the signaling event comprises one of the group of detecting speech input at the user equipment, receiving real-time protocol packets by using packet filters, and detecting floor control signaling.

6. The method according to claim 3, further comprising corresponding the first quality of service setting to one of the group of a best effort class and an interactive class, and corresponding the second quality of service setting to one of the group of an uplink streaming class, a downlink streaming class and a conversational class.

7. The method according to claim 3, further comprising corresponding the first quality of service setting to one of the group of an uplink streaming class, a downlink streaming class and a conversational class, and corresponding the second quality of service setting to one of the group of a best effort class and an interactive class.

8. A system which is configured to modify a packet data protocol context during an IP session, the system comprising:
at least one user equipment configured to activate a packet data protocol context with a first quality of service setting; and
at least one network element configured to detect a changed demand for resources within a session and provided with an ability to modify the packet data protocol context as an automated response to the changed demand for resources within the session so that the first quality of service setting is changed into a second quality of service setting different from the first quality of service setting, wherein the second quality of service setting corresponds to the changed demand for resources.

9. The system according to claim 8, wherein the system is configured so that the session comprises a push to talk over cellular session.

10. The system according to claim 8, wherein the network element includes the changed demand comprising a signaling event.

11. The system according to claim 10, wherein the network element includes the signaling event comprising one of the group of detected speech input at the network element, detected speech input at the user equipment, receipt of real-time protocol packets by using packet filters, and detected floor control signaling.

12. The system according to claim 8, wherein the network element comprises a timer and is further configured to start the timer if the changed demand for resources corresponds to a lower demand, and to modify the packet data protocol context if the timer expires without detecting another changed demand for resources corresponding to a higher demand with respect to the lower demand.

13. The system according to claim 9, wherein the first quality of service setting corresponds to one of the group of a best effort class and an interactive class, and the second quality of service setting corresponds to one of the group of an uplink streaming class, a downlink streaming class and a conversational class.

14. The system according to claim 9, wherein the first quality of service setting corresponds to one of the group of an uplink streaming class, a downlink streaming class and a conversational class, and the second quality of service setting corresponds to one of the group of a best effort class and an interactive class.

15. A network device configured to
modify a packet data protocol context during an IP session, wherein it is detected whether there is a changed demand for resources within the session, and
modify the packet data protocol context as an automated response to the changed demand for resources within the session,
wherein a first quality of service setting is changed into a second quality of service setting different from the first quality of service setting, and the second quality of service setting corresponds to the changed demand for resources.

16. The network device according to claim 15, wherein the session comprises a push to talk over cellular session.

17. The network device according to claim 15, wherein the changed demand comprises a signaling event.

18. The network device according to claim 17, further comprising a packet filter configured to receive real-time protocol packets as the signaling event.

19. The network device according to claim 17, further comprising a detected speech input as the signaling event.

20. The network device according to claim 17, further comprising a detected floor control signaling as the signaling event.

21. The network device according to claim 15, further comprising a timer, wherein the timer is started if it is detected that the changed demand for resources corresponds to a lower demand, and the packet data protocol context is modified if the timer expires without detecting another changed demand for resources corresponding to a higher demand with respect to the lower demand.

22. The network device according to claim 16, wherein the first quality of service setting corresponds to one of the group of a best effort class and an interactive class, and the second quality of service setting corresponds to one of the group of an uplink streaming class, a downlink streaming class and a conversational class.

23. The network device according to claim 16, wherein the first quality of service setting corresponds to one of the group of an uplink streaming class, a downlink streaming class and a conversational class, and the second quality of service setting corresponds to one of the group of a best effort class and an interactive class.

24. The network device according to claim 15, wherein the network device is a gateway GPRS support node (GGSN).

25. The network device according to claim 15, wherein the network device is a terminal.
